(19) United States
(12) Patent Application Publication
(10) Pub. No.: US 2019/0378380 A1
(43) Pub. Date: Dec. 12, 2019

(54) METHOD OF A MULTI-PLAYER POKER GAME, AND SYSTEM AND COMPUTER-READABLE MEDIUM FOR IMPLEMENTING THE METHOD

(71) Applicant: Midas Tech Pte Ltd., Taipei City (TW)

(72) Inventors: Chan-Guan KOH, Taipei City (TW); Yu-Song WU, Taipei City (TW); Tai-You TAN, Taipei City (TW); Hong-Wei CHANG, Taipei City (TW); Tze-Wen GLENN, QUAN, Taipei City (TW); Ming-Jie NG, Taipei City (TW)

(21) Appl. No.: 16/175,370

(22) Filed: Oct. 30, 2018

(30) Foreign Application Priority Data
Jun. 8, 2018 (TW) 107119770

(51) Int. Cl. G07F 17/32

(52) U.S. Cl. CPC G07F 17/3293; G07F 17/3272

(57) ABSTRACT

A method of managing a multi-player poker game to be implemented using a server device communicating with a plurality of client devices each associated with a player, the method including: dealing, to each of the players, a hand of cards including a predetermined number of playing cards and a wild card that can be used to represent any one of the poker cards; providing a game rule dictating that each of the players arranges the hand of cards dealt thereto into a playing card combination; and when it is determined that each of the players has arranged the hand of cards into a playing card combination, calculating a score for each of the players according to the playing card combinations arranged respectively by the players.

### CROSS-REFERENCE TO RELATED APPLICATION

This application claims priority of Taiwanese Patent Application No. 107119770, filed on Jun. 8, 2018.

### FIELD

The disclosure relates to a method of a multi-player poker game, and a system and computer-readable medium for implementing the method.

### BACKGROUND

Conventionally, poker may be used for a wide variety of card games (e.g., draw poker, stud poker, community card poker, Chinese poker, etc.). It is noted that in some variations, a wild card may be introduced such that a player is allowed to use the wild card to serve as any one playing card.

### SUMMARY

One object of the disclosure is to provide a method for implementing a multi-player poker game.

According to one embodiment of the disclosure, the method is implemented using a server device that allows connection with a plurality of client devices each associated with a player. The method includes steps of:

creating a virtual game room;

when more than two players join the virtual game room, dealing, to each of the players, a hand of cards including a predetermined number of playing cards from a deck of poker cards and a wild card that can be used to represent any one of the poker cards;

providing a game rule dictating that each of the players arranges the hand of cards dealt thereto into a playing card combination including a predetermined number of rows; and

when it is determined that each of the players has arranged the hand of cards into a playing card combination, calculating a score for each of the players according to the playing card combinations arranged respectively by the players.

Another object of the disclosure is to provide a server device for implementing a multi-player poker game.

According to one embodiment of the disclosure, the server device includes a processor, a data storage that stores a set of instructions, and a communication component that is configured to establish connection with a plurality of client devices each associated with a player. The processor is electrically connected to the data storage and the communication component, and is configured to execute the set of instructions to:

create a virtual game room;

when more than two players join the virtual game room, deal, to each of the players, a hand of cards including a predetermined number of playing cards from a deck of poker cards and a wild card that can be used to represent any one of the poker cards;

provide a game rule dictating that each of the players arranges the hand of cards dealt thereto into a playing card combination including a predetermined number of hands; and

when it is determined that each of the players has arranged the hand of cards into a playing card combination, calculate a score for each of the players according to the playing card combinations arranged respectively by the players.

Another object of the disclosure is to provide a non-transitory computer readable medium storing instructions that, when executed by a processor of a server device, causes the processor to perform steps of the above-mentioned method.

### BRIEF DESCRIPTION OF THE DRAWINGS

Other features and advantages of the disclosure will become apparent in the following detailed description of the embodiments with reference to the accompanying drawings, of which:

FIG. 1 is a block diagram illustrating a system for managing a multi-player poker game according to one embodiment of the disclosure;

FIG. 2 is a flow chart illustrating steps of a method for managing a multi-player poker game according to one embodiment of the disclosure;

FIG. 3 illustrates a newly created virtual game room;

FIG. 4 illustrates a multi-player poker game commencing in the virtual game room;

FIG. 5 illustrates one of the players arranging a hand of cards into a playing card combination;

FIG. 6 illustrates two exemplary playing card combinations;

FIG. 7 illustrates two playing card combinations from two players;

FIG. 8 illustrates a playing card combination from a six-card Chinese poker game;

FIG. 9 illustrates a playing card combination from a 13-card Chinese poker game; and

FIG. 10 illustrates a playing card combination from a Classic Bullfight poker game.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

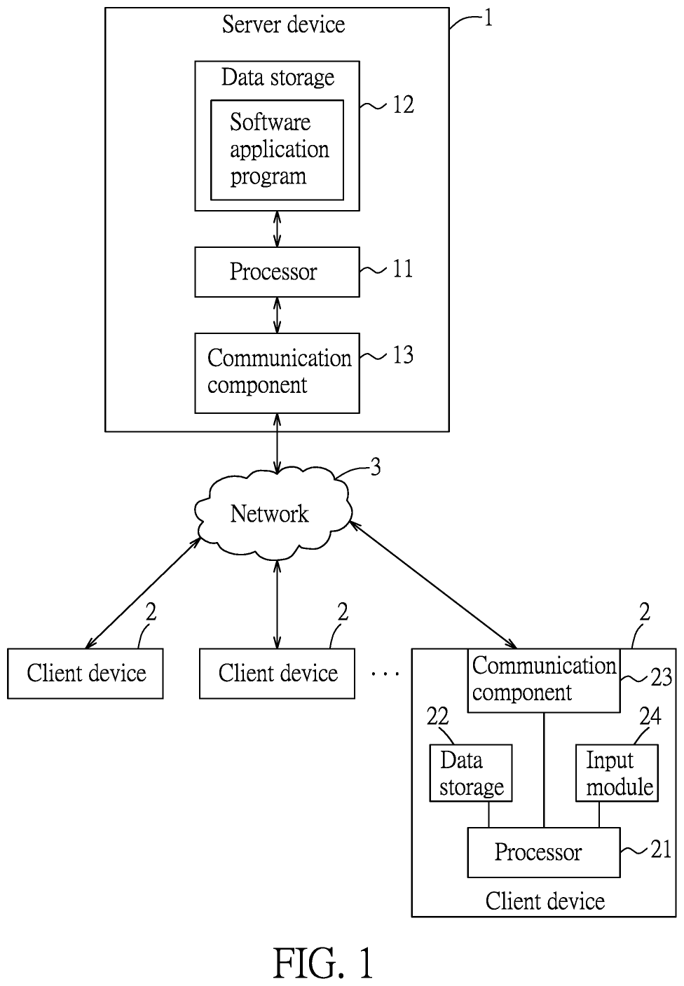

FIG. 1 is a block diagram illustrating a system for implementing a method of a multi-player poker game, according to one embodiment of the disclosure. The system includes a server device 1 and at least one client device 2.

The server device 1 includes a processor 11, a data storage 12 and a communication component 13.

The processor 11 may include, but not limited to, a single core processor, a multi-core processor, a dual-core mobile processor, a microprocessor, a microcontroller, a digital signal processor (DSP), a field-programmable gate array (FPGA), an application specific integrated circuit (ASIC), a radio-frequency integrated circuit (RFIC), etc.

The data storage 12 is coupled to the processor 11, and may include, but not limited to, a hard disk, a flash drive, or various types of non-transitory storage medium. The data storage 12 may store an operating system (OS) and a software application program that when executed by the processor 11, causes the processor 11 to perform operations as described below.

The communicating component 13 may include a short-range wireless communicating module supporting short-range wireless communication using a wireless technology of Bluetooth® and/or Wi-Fi, etc., and a mobile communicating module supporting telecommunication using Long-Term Evolution (LTE), the third generation (3G) and/or fourth generation (4G) of wireless mobile telecommunications technology, and/or the like.

The server device 1 is capable of communication with the at least one client device 2 over a network 3 (e.g., the Internet). In this embodiment, a plurality of client devices 2 are present. When in communication with the client devices 2, the server device 1 is configured to serve as a host to a multi-player poker game, with each client device 2 being used for a different player of the multi-player poker game.

Each of the client devices 2 may be embodied using a personal computer, a tablet, a laptop, a mobile electronic device (e.g., a cell phone, a personal digital assistant (PDA), etc.), and includes a processor 21, a data storage 22, a communication component 23 and an input module 24.

For each of the client devices 2, the processor 21, the data storage 22 and the communication component 23 may be embodied in a manner similar to those of the processor 11, the data storage 12 and the communication component 13, respectively.

For example, the processor 21 may include, but not limited to, a single core processor, a multi-core processor, a dual-core mobile processor, a microprocessor, a microcontroller, a digital signal processor (DSP), a field-programmable gate array (FPGA), an application specific integrated circuit (ASIC), a radio-frequency integrated circuit (RFIC), etc.

The data storage 22 is coupled to the processor 21, and may include, but not limited to, a hard disk, a flash drive, or various types of non-transitory storage medium. The data storage 22 may store an operating system (OS) and a software application program that when executed by the processor 21, causes the processor 21 to perform operations as described below.

The communicating component 23 may include a short-range wireless communicating module supporting short-range wireless communication using a wireless technology of Bluetooth® and/or Wi-Fi, etc., and a mobile communicating module supporting telecommunication using Long-Term Evolution (LTE), the third generation (3G) and/or fourth generation (4G) of wireless mobile telecommunications technology, and/or the like.

The input module 24 may include a keyboard and/or a mouse. In the cases that the client device 2 is a mobile electronic device, the input module 24 may be implemented using a touch screen.

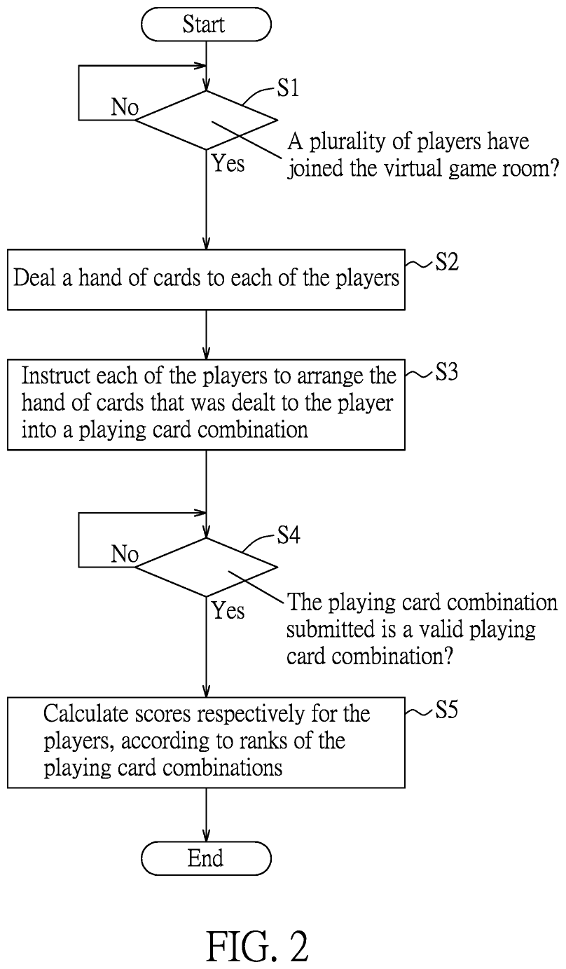

FIG. 2 is a flow chart illustrating steps of the method of a multi-player poker game, according to one embodiment of the disclosure. In this embodiment, the method is implemented by the system as described in FIG. 1.

When a user of one client device 2 intends to play a multi-player poker game, he/she may operate the client device 2 (a mobile device in this embodiment) to execute the software application program on the client device 2. In turn, the processor 21 may control the communication component 23 to establish communication with the server device 1.

After the client device 2 is in communication with the server device 1, the processor 21 controls the touch screen to display a selection screen having a number of options (e.g., a number of games that are available for playing, including poker games).

The user may then operate the selection screen to select one of the options. When a selection of a featured poker game is made, the processor 21 generates a request for playing the featured poker game and controls the communication component 23 to transmit the request to the server device 1.

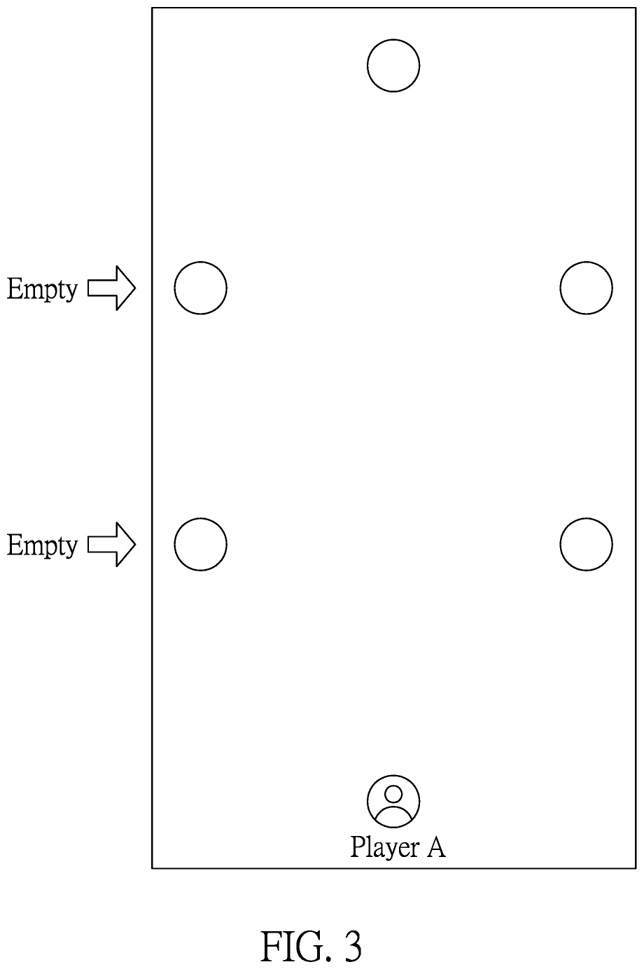

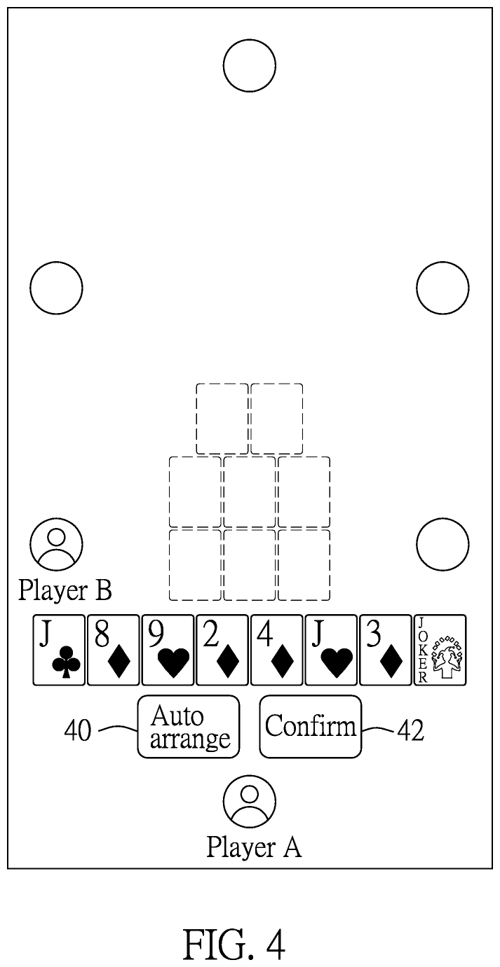

In turn, the server device 1 is configured to create a virtual game room for the user, who is to serve as a player. FIG. 3 illustrates an exemplary virtual game room that is newly created for the user (identified as player A). It is noted that the user may also select to join an existing virtual game room. For example, FIG. 4 illustrates an existing virtual game room, which another player (identified as player B) has already joined.

In step S1, the server device 1 determines whether a plurality of players have joined the virtual game room. In this embodiment, a poker game will commence when at least two players have joined the virtual game room. When only one player is in the virtual game room, the poker game is put on hold, and will commence when a second player joins.

It is noted that in other embodiments, based on game rules of the specific poker game, the poker game may commence when different numbers of players have joined.

After the poker game commences, in step S2, the server device 1, acting as a host, deals a hand of cards to each of the players.

Throughout the disclosure, the term “a hand of cards” refers to a number of poker cards that can be used by the player to form a hand. In one example as shown in FIG. 4, the hand of cards includes eight cards, and the poker game is an eight-card variation of Chinese poker. It is noted that in other embodiments, the hand of cards includes at least four cards.

Specifically, in this embodiment, the hand of cards that is dealt to each of the players includes a predetermined number of playing cards from one or more decks of poker cards, and one wild card (e.g., the Joker) that can be used to represent any one of the poker cards. In the example of FIG. 4, the hand of cards includes seven playing cards and one wild card. Additionally, only the hand of cards that is dealt to the player (e.g., player A) is visible to the player himself/herself.

Afterward, in step S3, the host instructs each of the players to arrange the hand of cards that was dealt to the player into a playing card combination. Specifically, the playing card combination is to be arranged based on a set of the game rules dictating that each of the players arranges the hand of cards dealt thereto into a playing card combination including a predetermined number of rows.

As illustrated in FIG. 4, the instruction made by the host may be a visual cue having eight blocks each having a shape identical to a shape of the poker card, so as to instruct the player to associate one of the cards in the hand of cards to one of the blocks. For example, the user can first select one of the cards of the hand of cards by touching a part of the touch screen that displays one of the cards (e.g., Jack of club seen in FIG. 4). In response, Jack of club may be highlighted or displayed in another way (e.g., as if being lifted) so as to visually notify the user that Jack of club is selected. Then, the user may touch one of the blocks (e.g., a left block in a front row) to associate Jack of club to that block. In another example, the cards may be associated to the blocks in a drag-and-drop manner. Specifically, the user may touch and hold the part of the touch screen that displays one of the cards (e.g., Jack of heart seen in FIG. 4), drag Jack of heart onto another block (e.g., a right block in the front row), and let go of the touch screen (i.e., “drop” Jack of heart).

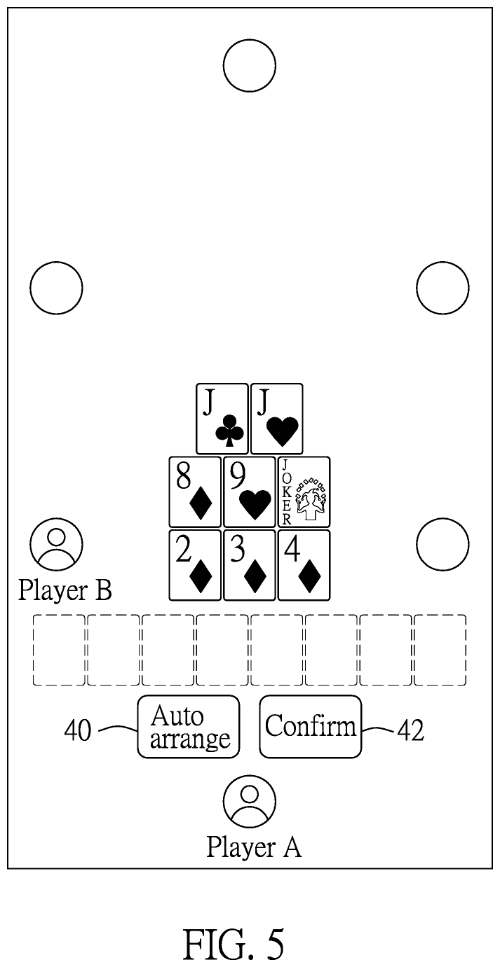

In the example of FIG. 5, the eight cards are arranged into three different rows and arranged in a front-to-back order. In other embodiments, depending on the game rules of the poker game, a predetermined number of rows included in the playing card combination may be from 2 to 4. After the player has completed the arrangement, he/she is instructed to click a “confirm” button 42 that is displayed on the touch screen, so as to submit the playing card combination to the server device 1.

In step S4, the server device 1 determines, for each of the players, whether the playing card combination submitted via the client device 2 is a valid playing card combination.

Specifically, the game rules further dictate that the predetermined number of rows has to satisfy a relation that a back one of successive two rows in the playing card combination has a rank higher than a rank of a front one of the successive two rows.

That is to say, each of the rows is associated with a poker hand (also known as “setting”), and a rank of a poker hand of a back one of successive two rows must be higher than a rank of a poker hand of a front one of the successive two rows.

It is noted that in determining the ranks for each of the rows, when the wild card is involved in one of the rows, the wild card may be used to represent a specific playing card such that the one of the rows has a highest possible rank.

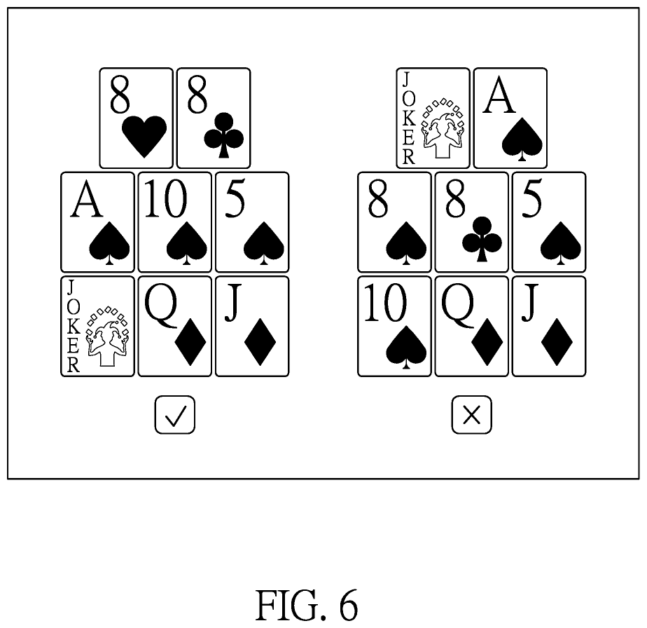

For example, FIG. 6 illustrates two possible playing card combinations each having three rows (a front row, a middle row and a back row). The playing card combination on the left has a front row having a pair of “8's”, a middle row having a flush of spades, which is greater in rank than a pair, and a back row having a straight flush (where the wild card is taken as a king of diamond), which is greater in rank than a flush. As a result, the playing card combination on the left satisfies the relation and is considered a valid playing card combination.

The playing card combination on the right has a front row having a pair of Aces (where the wild card is taken as an Ace), a middle row having a pair of “8's”, which is lower in rank than a pair of Aces, and a back row having a high card of Queen, which is lower in rank than a pair of 8's. As a result, the playing card combination on the right does not satisfy the relation and is considered an invalid playing card combination.

In some embodiments, in order to satisfy the relation, the wild card may be employed to represent other cards than the one that renders the highest possible rank in the one of the rows.

When it is determined that an invalid playing card combination is submitted by one of the players, the server device 1 may transmit an alert message instructing the player to rearrange the hand of rows. When it is determined that all playing card combinations submitted respectively by the players are valid, the flow proceeds to step S5.

In some embodiments, the user may be provided with an automatic arranging feature to automatically arrange the hand of cards (as shown in FIGS. 4 and 5, displaying an automatic arranging button 40 with such a function).

When one of the players presses the automatic arranging button 40, an automatic arrangement command is transmitted to the corresponding client device 2.

In response, the corresponding client device 2 is configured to automatically divide the hand of cards into the predetermined number of rows satisfying the relation so as to forma valid playing card combination. For example, the corresponding client device 2 executing the software application program may perform a calculation to determine a playing card combination that is valid, or to transmit the automatic arrangement command to the server device 1, which in turn performs the calculation to determine a playing card combination that is valid, and transmits information associated with the calculated playing card combination to the corresponding client device 2.

In some embodiments, after the hand of cards is dealt, the host initiates a countdown (e.g., 30 seconds). Upon the countdown reaching zero, when the predetermined number of rows arranged by one of the players does not satisfy the relation, the host may impose a penalty on a score of the one of the players.

It is noted that in other embodiments, the playing card combination is not checked for validity by the server device 1, and the process of step S4 may be omitted.

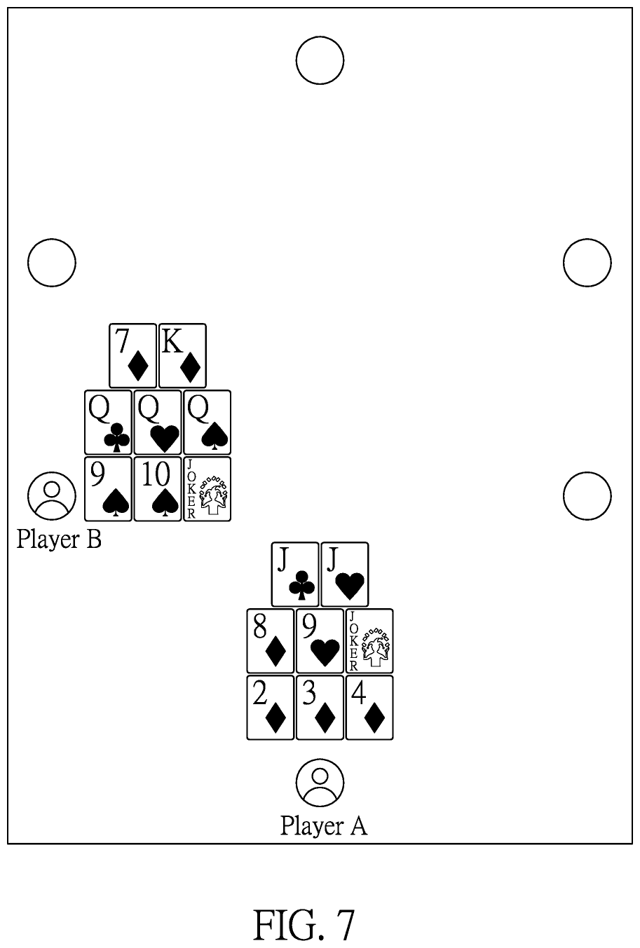

In step S5, the poker game is in a showdown state, in which all playing card combinations are compared in order to calculate scores respectively for the players, according to ranks of the playing card combinations arranged respectively by the players. In an example shown in FIG. 7, each of the three rows will be compared individually.

Regarding the front rows, player A has a pair of Jacks, while player B has a high card of King. As such, player A wins in the competition of the front rows. A specific score associated with a front row pair is added to player A. In some embodiments, a specific score is deducted from player B.

Regarding the middle rows, player A has a flush (where the wild card is used as a “10”), while player B has a three-of-a-kind Queens. As such, player B wins in the competition of the middle rows. A specific score associated with a middle row of three-of-a-kind is added to player B. In some embodiments, a specific score is deducted from player A.

Regarding the back rows, player A has a straight flush, while player B also has a straight flush (where the wild card is used as a Jack of spade). Player B wins in the competition of the back rows since the face values (9, 10, Jack) of the back row of player B are larger than those of player A (2, 3, 4). A specific score associated with a back row of straight flush is added to player B. In some embodiments, a specific score is deducted from player A.

Generally, when one of the players (e.g., player C as seen in FIG. 7) has an invalid playing card combination, it is considered that the one of the player goes “bust”, and will automatically lose each of the rows regardless of the ranks of the other player(s).

It is noted that, in some embodiments, in calculating the scores, a row that includes the wild card may be seen to have a different rank of one that does not include the wild card.

For example, in the example of FIG. 7, it is assumed that player C has a front row consisting of a Jack and the wild card. Based on preset rules of the virtual game room, player A may be deemed the winner for not including a wild card (i.e., the wild card is considered to have a rank that is lower than a rank of the poker card represented by the wild card in the playing card combination). Alternatively, player C may be deemed the winner for including a wild card (i.e., the wild card is considered to have a rank that is higher than a rank of the poker card represented by the wild card in the playing card combination).

The above cases may be common when a large number of players are in the virtual game room, and more than one stack of poker cards is needed for the poker game. For example, when more than seven players are in the virtual game room playing the eight-card Chinese poker, a second stack of poker cards is used.

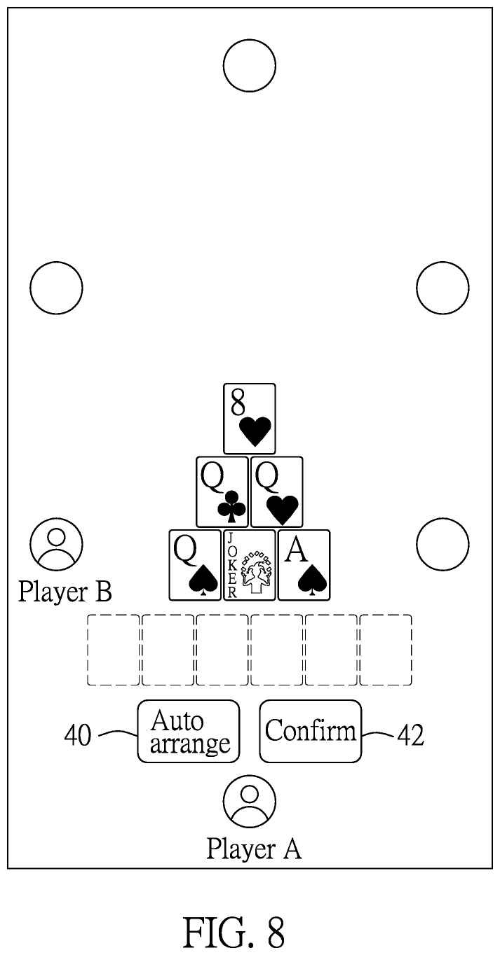

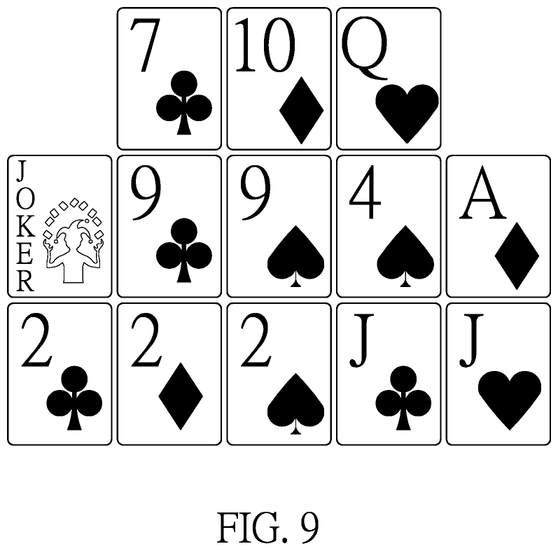

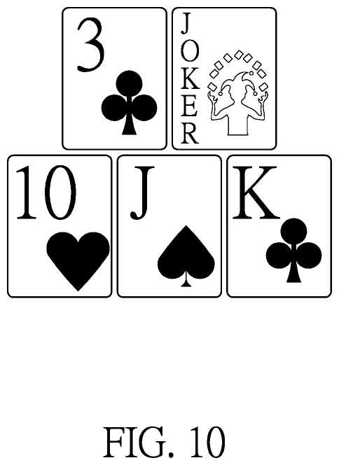

While the eight-card Chinese poker is described in this embodiment, the above method may be applied in other embodiments to other poker games such as six-card Chinese poker (as shown in FIG. 8), traditional 13-card Chinese poker (as shown in FIG. 9), Open-face Chinese poker (OFCP), Classic Bullfight poker (as shown in FIG. 10).

In some embodiments, when the hand of cards includes a large number of poker cards (e.g., more than 8), for example in 13-card Chinese poker, more than one wild card may be included in the hand of cards dealt to each of the players. In some embodiments, when multiple wild cards are included in each hand of cards, each of the wild cards may have different uses and ranks.

According to one embodiment of the disclosure, there is provided a non-transitory computer readable medium storing instructions that, when executed by a processor of a server device, causes the processor to perform steps of a method for managing a multi-player poker game as described above.

To sum up, embodiments of the disclosure provide a method, a server device and a non-transitory computer readable medium that is configured to manage a multi-player poker game that, with each of the players being dealt with at least one wild card, provide more variation and possible outcomes to the poker game.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A method of a multi-player poker game to be implemented using a server device that allows connection with a plurality of client devices each associated with a player, the method comprising steps of:
creating a virtual game room;
when more than two players join the virtual game room, dealing, to each of the players, a hand of cards including a predetermined number of playing cards from a deck of poker cards and a wild card that can be used to represent any one of the poker cards;
providing a game rule dictating that each of the players arranges the hand of cards dealt thereto into a playing card combination including a predetermined number of rows; and
when it is determined that each of the players has arranged the hand of cards into a playing card combination, calculating a score for each of the players according to the playing card combinations arranged respectively by the players.

2. The method of claim 1, further comprising, after the step of dealing a hand of cards, steps of:
instructing each of the players to divide the hand of cards dealt thereto into the predetermined number of rows and to arrange the predetermined number of rows in a front-to-back order so as to form the playing card combination;
for each of the playing card combinations arranged respectively by the players, determining whether the predetermined number of rows satisfies a relation that a back one of successive two rows in the playing card combination has a rank higher than a rank of a front one of the successive two rows; and
when it is determined that the predetermined number of rows arranged by one of the players does not satisfy the relation, instructing the player to rearrange the hand of cards.

3. The method of claim 2, further comprising, after the step of instructing each of the players to divide the hand of cards, steps of:
initiating a countdown;
upon the countdown reaching zero, when the predetermined number of rows arranged by one of the players does not satisfy the relation, imposing a penalty on the score of the one of the players.

4. The method of claim 2, further comprising, after the step of dealing a hand of cards, steps of:
in response to receipt of an automatic arrangement command inputted by one of the players, automatically dividing the hand of cards of the one of the players into the predetermined number of rows satisfying the relation so as to form the playing card combination for the one of the players.

5. The method of claim 1, wherein, in the step of calculating a score, the wild card is considered to have a rank that is higher than a rank of the poker card represented by the wild card in the playing card combination.

6. The method of claim 1, wherein, in the step of calculating a score, the wild card is considered to have a rank that is lower than a rank of the poker card represented by the wild card playing card combination.

7. A server device for implementing a method of a multi-player poker game, comprising:
a data storage that stores a set of instructions;
a communication component that is configured to establish connection with a plurality of client devices each associated with a player; and
a processor electrically connected to said data storage and said communication component, and configured to execute the set of instructions to:
create a virtual game room;
when more than two players join the virtual game room, deal, to each of the players, a hand of cards including a predetermined number of playing cards from a deck of poker cards and a wild card that can be used to represent any one of the poker cards;
provide a game rule dictating that each of the players arranges the hand of cards dealt thereto into a playing card combination including a predetermined number of hands; and
when it is determined that each of the players has arranged the hand of cards into a playing card combination, calculate a score for each of the players according to the playing card combinations arranged respectively by the players.

8. The server device of claim 7, wherein in dealing a hand of cards, said processor is further configured to execute the set of instructions to:
instruct each of the players to divide the hand of cards dealt thereto into the predetermined number of rows and to arrange the predetermined number of rows in a front-to-back order so as to form the playing card combination;
for each of the playing card combinations arranged respectively by the players, determine whether the predetermined number of rows satisfies a relation that a back one of successive two rows in the playing card combination has a rank higher than a rank of a front one of the successive two rows; and
when it is determined that the predetermined number of rows arranged by one of the players does not satisfy the relation, instruct the player to rearrange the hand of cards.

9. The server device of claim 8, wherein, after instructing each of the players to divide the hand of cards, said processor is further configured to execute the set of instructions to:
initiate a countdown;
upon the countdown reaching zero, when the predetermined number of rows arranged by one of the players does not satisfy the relation, impose a penalty on the score of the one of the players.

10. The server device of claim 8, wherein, after instructing each of the players to divide the hand of cards, said processor is further configured to execute the set of instructions to:
in response to receipt of an automatic arrangement command inputted by one of the players, automatically divide the hand of cards of the one of the players into the predetermined number of rows satisfying the relation so as to form the playing card combination for the one of the players.

11. The server device of claim 7, wherein, in calculating a score, the wild card is considered by said processor to have a rank that is higher than a rank of the poker card represented by the wild card in the playing card combination.

12. The server device of claim 7, wherein, in calculating a score, the wild card is considered by said processor to have a rank that is lower than a rank of the poker card represented by the wild card in the playing card combination.

13. A non-transitory computer readable medium storing instructions that, when executed by a processor of a server device, causes the processor to perform steps of a method comprising;
creating a virtual game room;
when more than two players join the virtual game room via at least one client device, dealing, to each of the players, a hand of cards including a predetermined number of playing cards from a deck of poker cards and a wild card that can be used to represent any one of the poker cards;
providing a game rule dictating that each of the players arranges the hand of cards dealt thereto into a playing card combination including a predetermined number of rows; and
when it is determined that each of the players has arranged the hand of cards into a playing card combination, calculating a score for each of the players according to the playing card combinations arranged respectively by the players.
